(19) United States
(12) Patent Application Publication
(10) Pub. No.: US 2019/0231629 A1
(43) Pub. Date: Aug. 1, 2019

(54) SEATED INVERSION TABLE

(71) Applicant: Yi Tzu CHEN, Taoyuan City (TW)

(72) Inventor: Yi Tzu CHEN, Taoyuan City (TW)

(21) Appl. No.: 15/883,072

(22) Filed: Jan. 29, 2018

(51) Int. Cl. A61H 1/00

(52) U.S. Cl. CPC A61H 1/001; A61H 2203/0431; A61H 2201/164

(57) ABSTRACT

A seated inversion table has a support frame assembly, two hand rest assemblies, a seat assembly, and a foot-clamping frame assembly. The support frame assembly has fixing portions. Each hand rest assembly is pivotably mounted on the support frame assembly and has a hand rest and a controlling set. The controlling set is securely mounted on the hand rest and selectively fixed on the fixing portions. The seat assembly is pivotably mounted on the support frame assembly. The foot-clamping frame assembly is mounted on the support frame assembly. When the controlling assemblies are fixed on the fixing portions, the seated inversion table cannot be tilted. When the controlling assemblies are not fixed on the fixing portions, the seated inversion table can be tilted. Thus, the user can adjust the angle of the seated inversion table when sitting on the seated inversion table rather than leave the seated inversion table.

### BACKGROUND OF THE INVENTION

### 1. Field of the Invention

The present invention relates to a seated inversion table, especially to a seated inversion table that can be adjusted to tilt at different angles.

### 2. Description of the Prior Arts

A seated inversion table is used for relieving discomfort caused by osteophytes, commonly referred to as bone spurs. In other words, the seated inversion table is rehabilitation equipment that allows a patient to appropriately exercise on it for stretching the abdominal muscles and back muscles.

Because a structure of the seated inversion table is dedicated to a particular use, the seated inversion table does not suit for other applications. A conventional seated inversion table comprises a frame assembly, a seat assembly, and a belt. Two ends of the belt are connected to the frame assembly and the seat assembly, and thereby a tilting angle of the seat assembly can be controlled via adjusting a length of the belt beforehand. However, to sustain a weight of the tilted seat assembly, the belt is always mounted under the seat assembly. Therefore, if a user wants to adjust the tilting angle after performing inversion, the user has to return to sit uprightly, leave the seat assembly to adjust the belt, and then sit on the seat assembly again and perform inversion again. In other words, the conventional seated inversion table is not convenient to use.

Besides, again because of the structure of the seated inversion table, a space occupied by the seated inversion table is large. Therefore, for people living in the metropolitan area that is densely populated, it is hard to have adequate space for setting the seated inversion table.

To overcome the shortcomings, the present invention provides a seated inversion table to mitigate or obviate the aforementioned problems.

### SUMMARY OF THE INVENTION

The main objective of the present invention is to provide a seated inversion table that can be adjusted in the tilting angle conveniently.

The seated inversion table has a support frame assembly, two hand rest assemblies, a seat assembly, and a foot-clamping frame. The support frame assembly comprises two first support rods disposed at two sides of the support frame assembly respectively. Each one of the first support rods comprises a fixing portion and two second support rods. An upper end of each one of the second support rods is mounted on a respective one of the first support rods. The two hand rest assemblies are pivotably mounted on the two sides of the support frame assembly respectively. Each one of the hand rest assemblies comprises a linking set, a hand rest, and a controlling set. The two linking sets of the two hand rest assemblies are connected to the two first support rods respectively or connected to the two second support rods respectively. The hand rest is securely mounted on the linking set. The controlling set is securely mounted on the hand rest. The two controlling sets of the two hand rest assemblies are selectively fixing the two fixing portions of the two first support rods respectively. The seat assembly pivotably is mounted on the support frame assembly and comprises a seat frame, a seat cushion, and a back cushion. The seat frame is pivotably mounted on the support frame assembly, and between the two first support rods or between the two second support rods. The seat cushion is securely mounted on the seat frame. The back cushion is pivotably mounted on the support frame assembly. The foot-clamping frame assembly is mounted on the support frame assembly. When the two controlling sets respectively fix the two fixing portions, the linking set of the two hand rest assemblies, the seat cushion, and the back cushion are non-tiltable; when the two controlling sets do not fix the two fixing portions, the linking set of the two hand rest assemblies, the seat cushion, and the back cushion are tiltable.

Therefore, the seated inversion table of the present invention allows the user to adjust the angle of the seated inversion table when sitting on the seated inversion table via the controlling set mounted on the hand rest, rather than leave the seated inversion table, so the seated inversion table provides more convenience. Besides, the seated inversion table can be used as a normal chair, so even when the user is not doing the inversion exercise, the seated inversion table still can be used. Therefore, the user does not have to reserve another space for accommodating the seated inversion table.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a seated inversion table in accordance with the present invention;

FIG. 2 is a side view of the seated inversion table in FIG. 1;

FIG. 3 is an enlarged view of a hand rest assembly of the seated inversion table in FIG. 1;

FIG. 4 is another enlarged view of the hand rest assembly of the seated inversion table in FIG. 1;

FIG. 5 is still another enlarged view of the hand rest assembly of the seated inversion table in FIG. 4 showing the handle of the hand rest assembly being pushed;

FIG. 6 a side view of the seated inversion table in FIG. 1 showing the seated inversion table being tilted;

FIG. 7 a side view of the seated inversion table in FIG. 1 showing the seated inversion table being tilted further;

FIG. 8 a perspective view of the seated inversion table in FIG. 1 showing a foot-clamping frame assembly of the seated inversion table is folded; and

FIG. 9 a side view of the seated inversion table in FIG. 1 showing the foot-clamping frame assembly is folded.

### DETAILED DESCRIPTION OF THE PREFERRED EMBODIMENTS

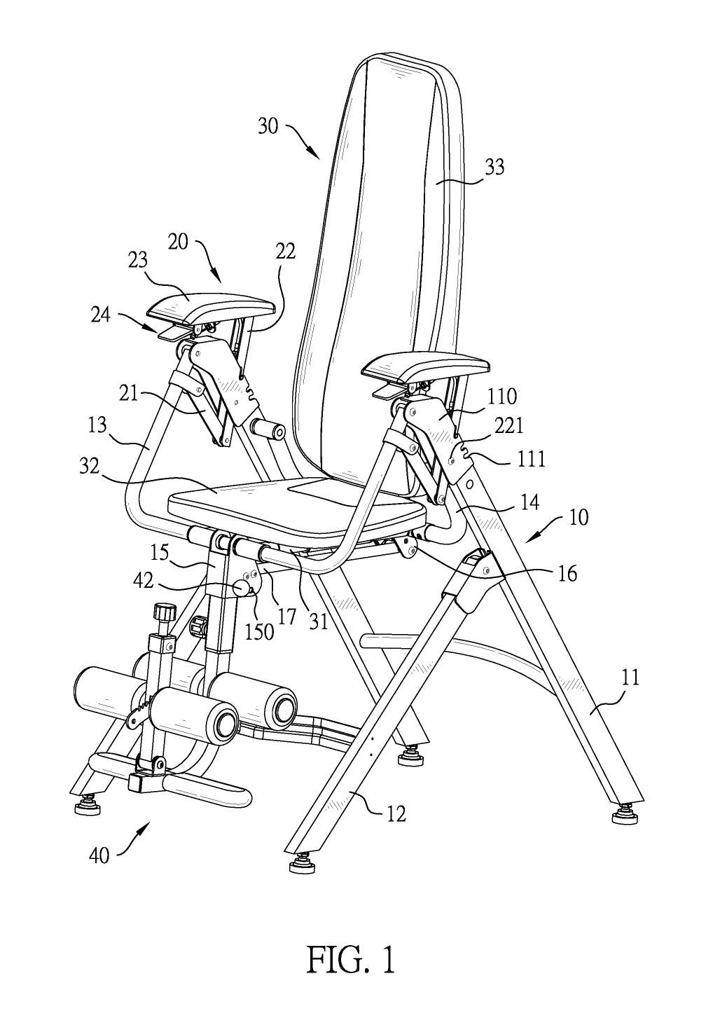

Please refer to FIGS. 1 to 3 first. A seated inversion table in accordance with the present invention is provided and comprises a support frame assembly 10, two hand rest assemblies 20, a seat assembly 30, and a foot-clamping frame assembly 40.

The support frame assembly 10 comprises two first support rods 11, two second support rods 12, at least one front swinging rod 13, at least one rear swinging rod 14, a first tilting frame 15, a second tilting frame 16, and a driving rod 17.

The two first support rods 11 are respectively disposed on two sides of support frame assembly 10. Each first support rod 11 extends downward and rearward. In this embodiment, each first support rod 11 is a hollow tube. Each first support rod 11 comprises a fixing portion 110, and, in this embodiment, the fixing portion 110 is mounted at an upper end of the first support rod 11. Each fixing portion 110 forms a plurality of fixing cavities 111, each two fixing cavities 111 are defined as a pair, and the fixing cavities 111 of each pair face to each other and communicate with an inner space of the first support rod 11. Ends of the two second support rods 12 are respectively and pivotably mounted on the first support rods 11. Each second support rod 12 extends downward and frontward from the corresponding first support rod 11.

Each one of the at least one front swinging rod 13 extends downward and frontward, and one end of each one of the at least one front swinging rod 13 is pivotably mounted on the first support rod 11. In this embodiment, the support frame assembly 10 has one front swinging rod 13 and the front swinging rod 13 is U-shaped. Two ends of the U-shaped front swinging rod 13 are respectively and pivotably mounted on the two first support rods 11. However, in another embodiment, the support frame assembly 10 may have two front swinging rods 13, and two upper ends of the two front swinging rods 13 are respectively and pivotably mounted on the two first support rods 11. Technical features of the rear swinging rod 14 are similar to the front swinging rod 13, e.g. the rear swinging rod 14 is U-shaped and two ends of the U-shaped rear swinging rod 14 are respectively and pivotably mounted on the first support rods 11, but the rear swinging rod 14 is disposed behind the front swinging rod 13.

The first tilting frame 15 is pivotably mounted on a bottom side of the U-shaped front swinging rod 13 and the second tilting frame 16 is pivotably mounted on a bottom side of the U-shaped rear swinging rod 14. The first tilting frame 15 comprises a plurality of first through holes 150. In this embodiment, the first tilting frame 15 has an inner space, and the first through holes 150 communicate with the inner space of the first tilting frame 15. Each two of the first through holes 150 are defined as a pair and thus the first tilting frame 15 has multiple pairs of the first through holes 150.

Two ends of the driving rod 17 are respectively and pivotably mounted on the first tilting frame 15 and a lower end of the second tilting frame 16. A pivot point of the driving rod 17 pivoting on the first tilting frame 15 is different from a pivot point of the bottom side of the front swinging rod 13 pivoting on the first tilting frame 15; a pivot point of the driving rod 17 pivoting on the second tilting frame 16 is also different from a pivot point of the rear swinging rod 14 pivoting on the second tilting frame 16.

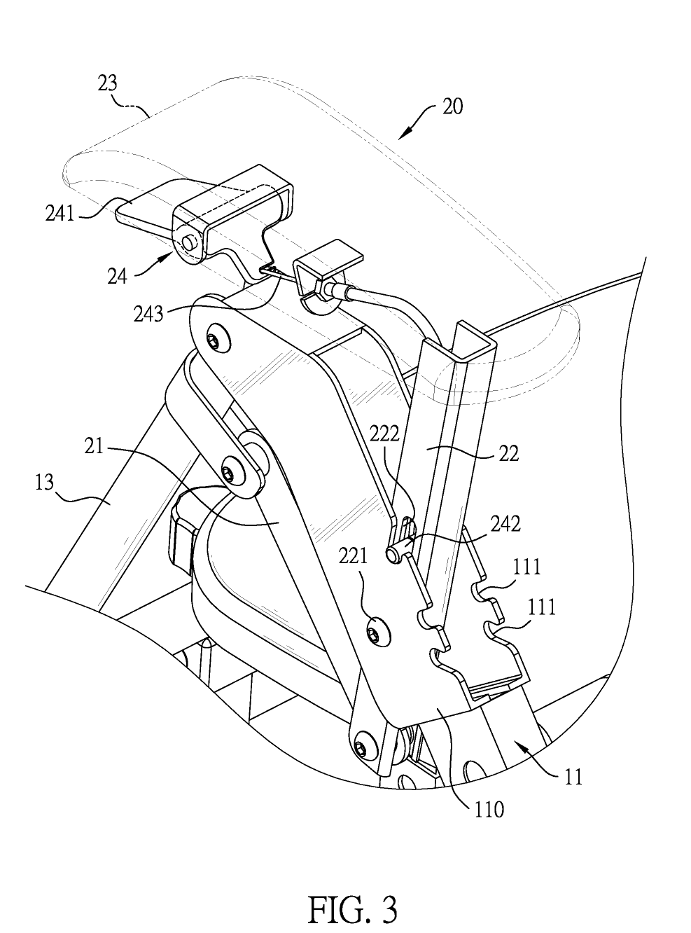

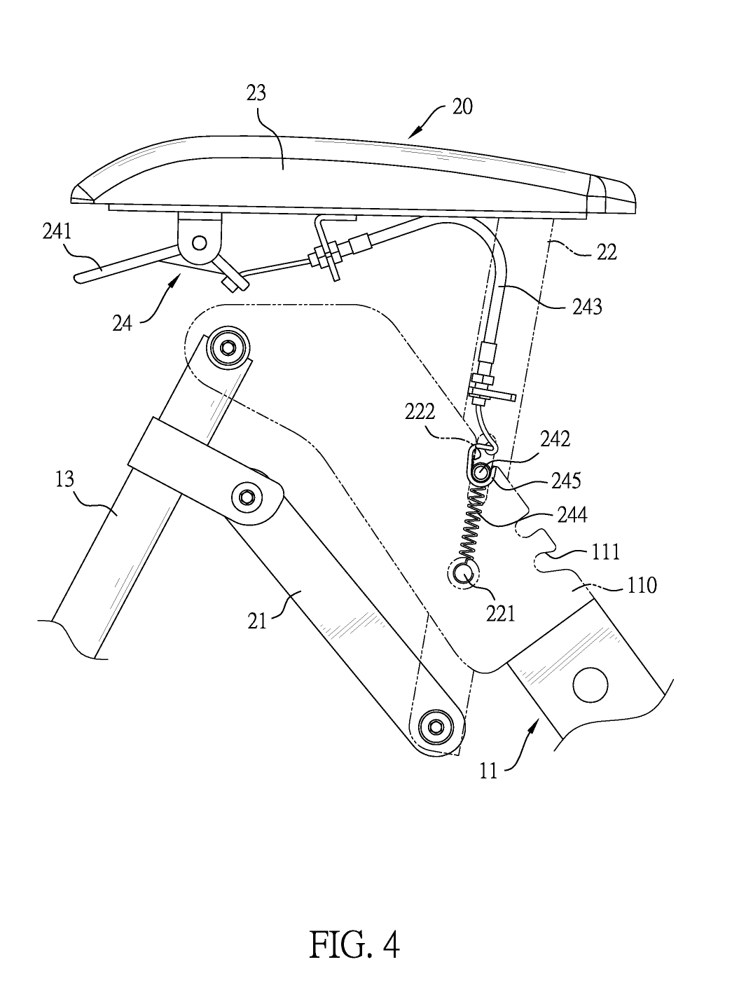

Then please refer to FIGS. 3 and 4. The two hand rest assemblies 20 are pivotably mounted on the two sides of the support frame assembly 10. Each hand rest assembly 20 comprises a linking set, a hand rest 23, and a controlling set 24. The linking set may include a connecting rod 21 and a driven rod 22, but it is not limited thereto.

The connecting rod 21 comprises a first end and a second end opposite to each other. The first end of the connecting rod 21 is pivotably mounted on one arm of the U-shaped front swinging rod 13 that is at the corresponding side of the support frame assembly 10. The driven rod 22 comprises an upper end and a lower end opposite to each other, and a middle portion between the upper end and the lower end. The middle portion of the driven rod 22 is pivotably mounted on the first support rod 11 that is at the corresponding side of the support frame assembly 10 and through the inner space of said first support rod 11. The lower end of the driven rod 22 is pivotably mounted on the second end of the connecting rod 21 of the corresponding hand rest assembly 20, and the hand rest 23 is securely mounted on the driven rod 22 of the corresponding hand rest assembly 20. The driven rod 22 is hollow and comprises a pivoting shaft 221 and two grooves 222. The pivoting shaft 221 is mounted on the middle portion of the driven rod 22 and through the first support rod 11 that is at the corresponding side of the support frame assembly 10. The driven rod 22 is capable of tilting about the pivoting shaft 221. The two grooves 222 communicate with an inner space of the driven rod 22, face to each other, and selectively face to one of the pairs of the fixing cavities 111.

The controlling set 24 is securely mounted on the hand rest 23 of the corresponding hand rest assembly 20 and is selectively fixed on the fixing portion 110 that is at the corresponding side of the support frame assembly 10. Precisely, the controlling set 24 comprises a handle 241, an engaging component 242, a cable 243, and an elastic component 244. The handle 241 is movably or rotatably mounted on the hand rest 23 of the corresponding hand rest assembly 20. In this embodiment, the handle 241 may be rotatable, but it is not limited thereto, as long as the handle 241 is capable of driving the engaging component 242. The engaging component 242 is selectively engaged in the fixing cavity 111 of the fixing portion 110 that is at the corresponding side of the support frame assembly 10. In this embodiment, the engaging component 242 is movably mounted on the driven rod 22 of the corresponding hand rest assembly 20 and through the two grooves 222 and the inner space of the driven rod 22. In addition, the engaging component 242 is capable of moving in a lengthwise direction of the two grooves 222.

One end of the cable 243 is connected to the handle 241, and another end of the cable 243 is connected to the engaging component 242. Precisely, the cable 243 comprises a hook 245 at the end that is connected to the engaging component 242. In other words, the cable 243 hooks on the engaging component 242 via the hook 245. Therefore, the handle 241 is driven by the engaging component 242 to move into or out of the fixing cavities 111 via the cable 243. One end of the elastic component 244 is securely mounted on the pivoting shaft 221 of the driven rod 22 of the corresponding hand rest assembly 20, another end of the elastic component 244 is connected to the engaging component 242, and thereby the engaging component 242 tends to move toward the pivoting shaft 221 and move into one of the pairs of the fixing cavities 111.

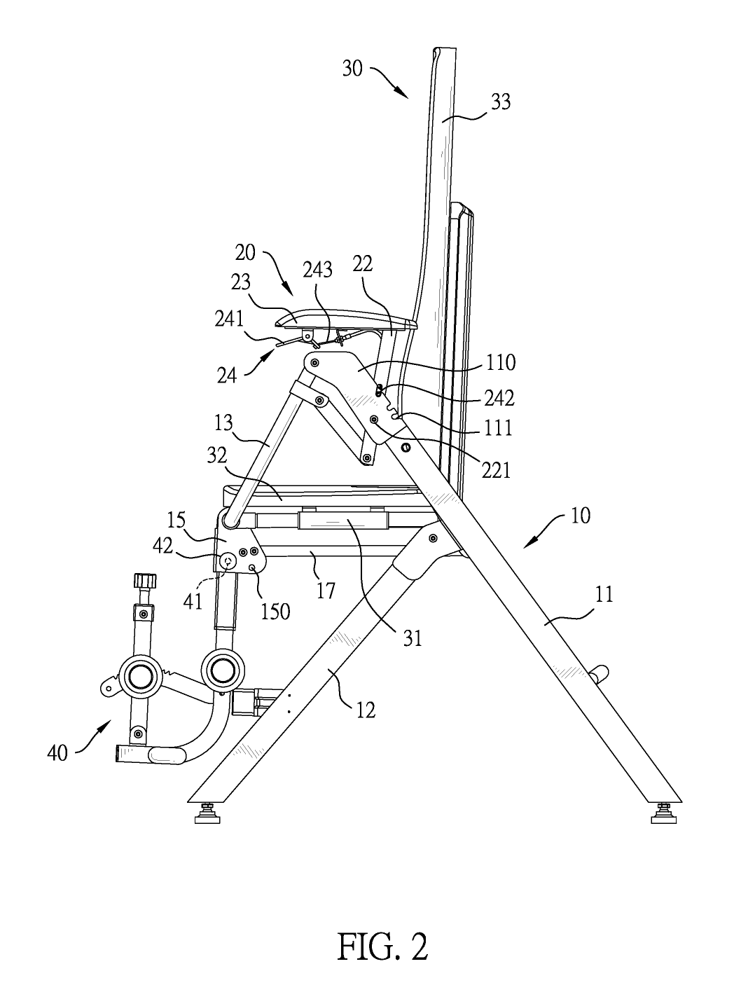

Then please refer to FIGS. 1 and 2. The seat assembly 30 is pivotably mounted on the support frame assembly 10. Precisely, the seat assembly 30 comprises a seat frame 31, a seat cushion 32, and a back cushion 33. The seat frame 31 is mounted between the two first support rods 11, but, in another embodiment the seat frame 31 may be mounted between the two second support rods 12. In this embodiment, the seat frame 31 is pivotably mounted between the two first support rods 11. Precisely, a front end of the seat frame 31 is pivotably mounted on the bottom side of the U-shaped front swinging rod 13, and a rear end of the seat frame 31 is pivotably mounted on the bottom of the U-shaped rear swinging rod 14. The driving rod 17 is parallel to and spaced apart from the seat frame 31.

The seat cushion 32 is securely mounted on the seat frame 31, and, in this embodiment, is located above the driving rod 17 and the first tilting frame 15. The back cushion 33 is pivotably mounted on the support frame assembly 10, and, in this embodiment, the back cushion 33 is securely mounted on the upper end of the second tilting frame 16 and is tiltable with the second tilting frame 16.

The foot-clamping frame assembly 40 is mounted on the support frame assembly 10 and is capable of being rotated to be parallel to the seat cushion 32. Precisely, the foot-clamping frame assembly 40 is pivotably mounted on the first tilting frame 15. The foot-clamping frame assembly 40 comprises at least one second through hole 41 and a pin 42. Each one of the at least one second through hole 41 selectively faces to one pair of the first through holes 150. The pin 42 is selectively mounted in the second through hole 41 and the pair of the first through holes 150 at the same time, thereby fixing an angle between the foot-clamping frame assembly 40 and the support frame assembly 10.

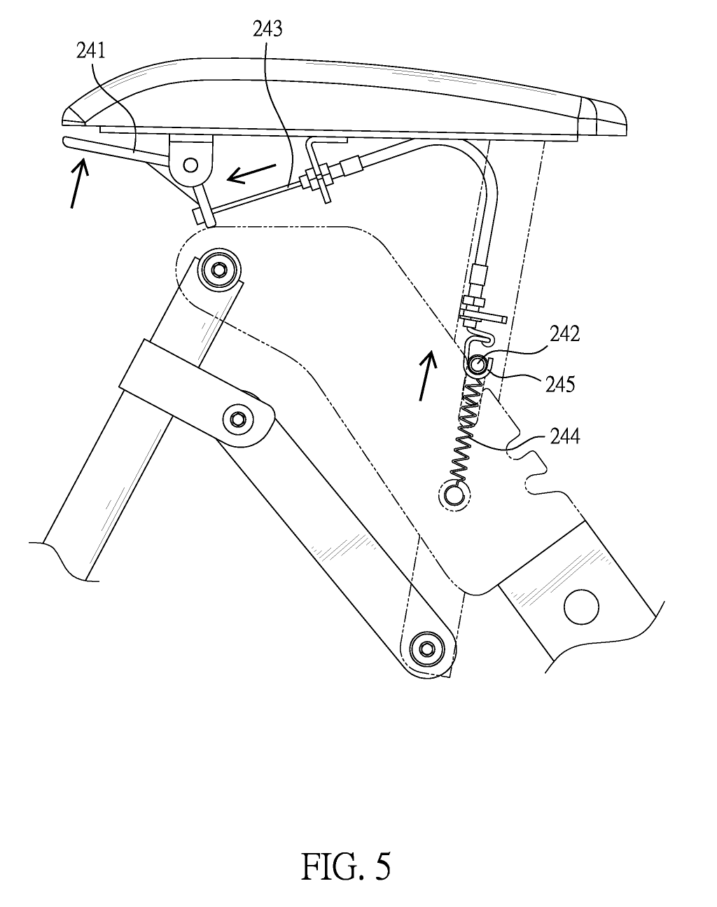

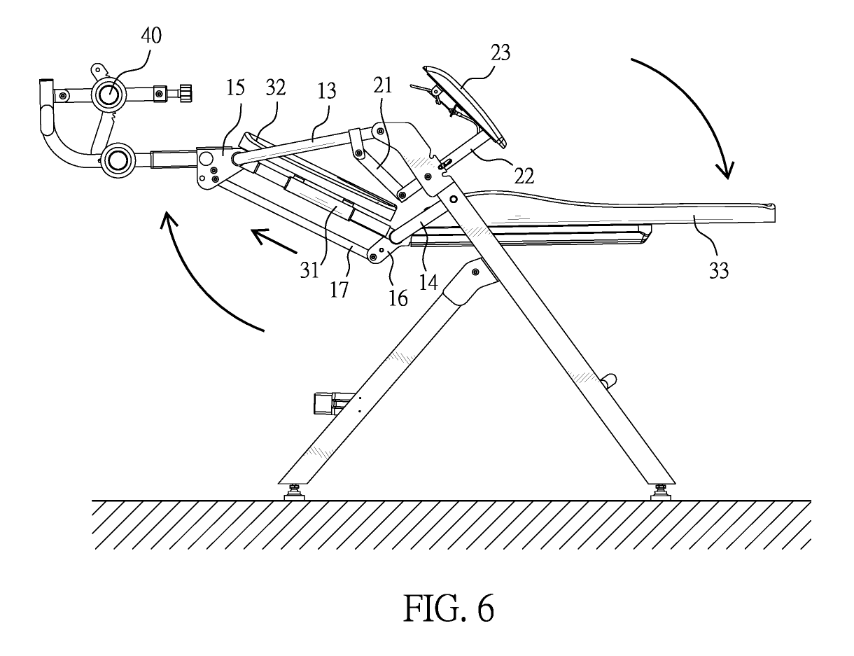

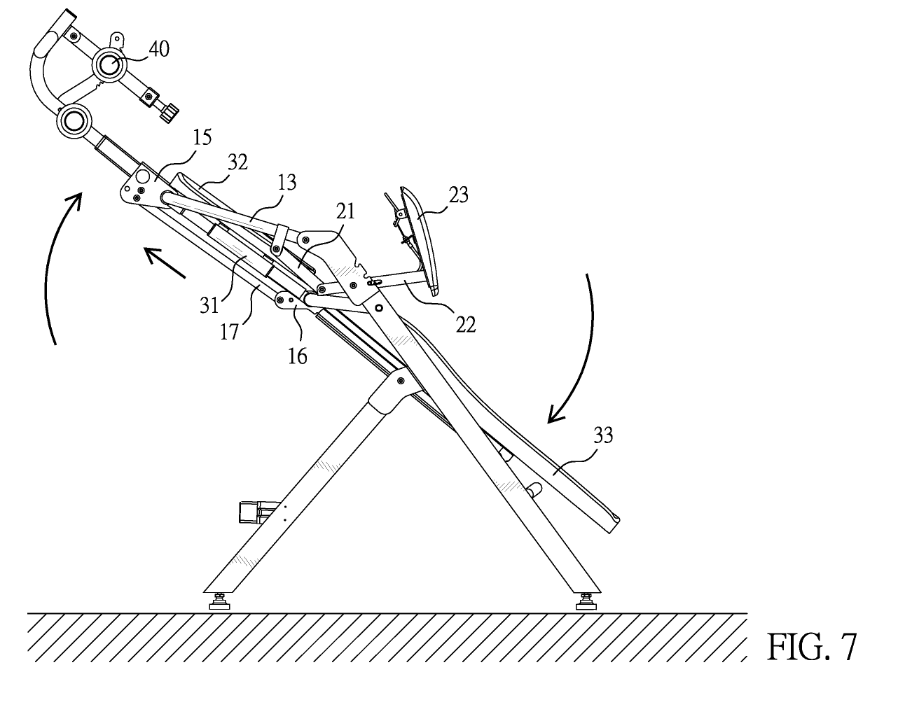

Then please refer to FIGS. 4 to 7. When operating the seated inversion table, a user can adjust the seated inversion table when sitting on the seated inversion table in lieu of leaving the seated inversion table for adjustment. Precisely, normally, when the user does not press the handle 241, the engaging component 242 engages one pair of the fixing cavities 111, so that the driven rod 22, the connecting rod 21, the front swinging rod 13, the rear swinging rod 14, the seat cushion 32, and the back cushion 33 cannot be tilted. To adjust the angle of the seated inversion table, the user can just press the handle 241 and thus the engaging component 242 moves out of the fixing cavities 111, and then when the user's back pushes the back cushion 33 to tilt rearward, the seat cushion 32, the front swinging rod 13, and the rear swinging rod 14 will be tilted and thus the connecting rod 21 and the driven rod 22 will be tilted as well. During tilting, the user may release the handle 241 to make the engaging component 242 pulled back toward the pivoting shaft 221 of the driven rod 22 via the elastic component 244. Therefore, when the driven rod 22 is tilted to specific angles, or, when the grooves 222 of the driven rod 22 face to the fixing cavities 111 of the fixing portion 110, the engaging component 242 is pulled into the fixing cavities 111 by the elastic component 244, which makes the driven rod 22 and other rods non-tiltable anymore so that the seated inversion table can be kept at this angle.

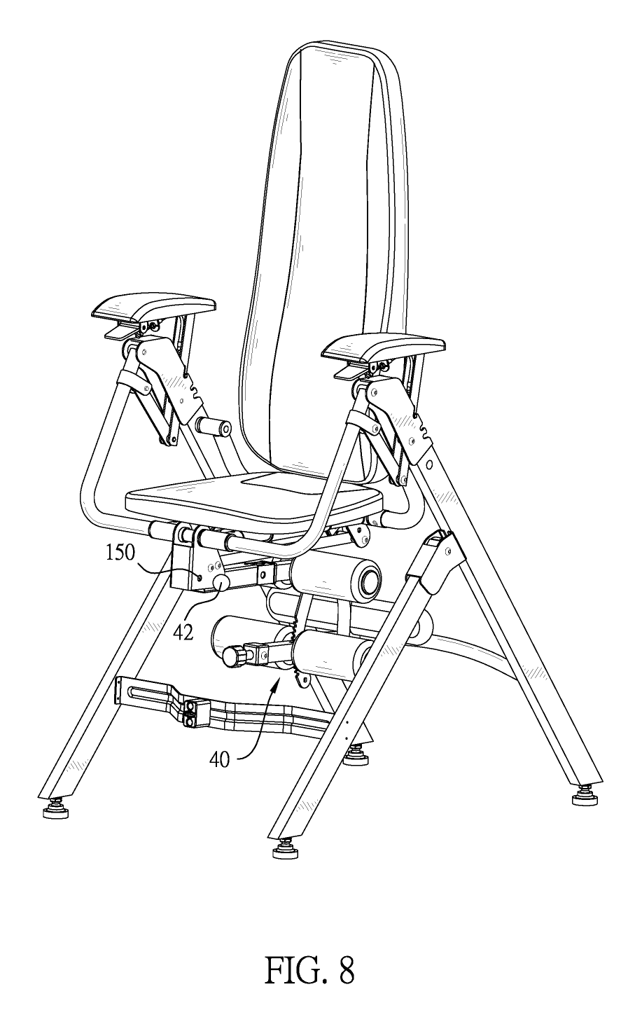

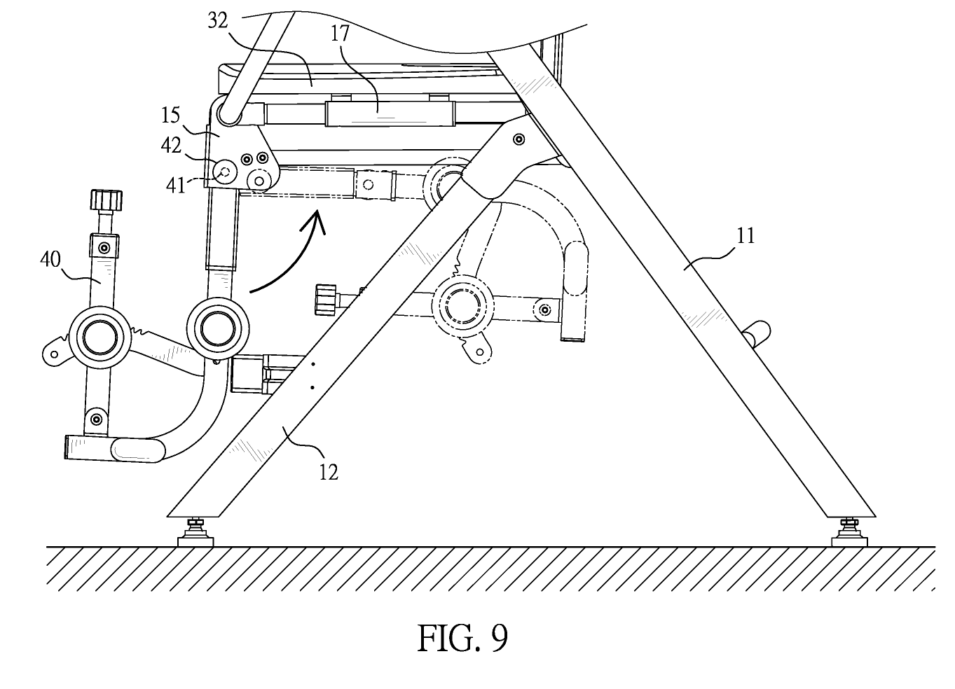

Then please refer to FIGS. 1, 8, and 9. If the user does not want to perform inversion, the seated inversion table of the present invention can be used for other proposes, e.g., the seated inversion table is capable of being utilized as a normal chair. To achieve the aforementioned goal, the foot-clamping frame assembly 40 can be folded and tilted to a position under the seat cushion 32. Precisely, when the pin 42 is detached from the first tilting frame 15, the foot-clamping frame assembly 40 can be tilted with respect to the support frame assembly 10. After the foot-clamping frame assembly 40 is tilted and makes the second through hole 41 face to the first through hole 150 of the first tilting frame 15, the pin 42 may be mounted through the second through hole 41 and the first through hole 150 for fixing an angle between the foot-clamping frame assembly 40 and the support frame assembly 10. Therefore, the foot-clamping frame assembly 40 can be folded to a position under the seat cushion 32 and thus the folded foot-clamping frame assembly 40 may not interfere with other activities of the user.

Consequently, the seated inversion table of the present invention allows the user to adjust the angle of the seated inversion table when sitting on the seated inversion table via the controlling set 24 mounted on the hand rest 23, rather than leave the seated inversion table, so the seated inversion table provides more convenience. Besides, the seated inversion table can be used as a normal chair, so even when the user is not doing the inversion exercise, the seated inversion table still can be used. Therefore, the user does not have to reserve another space for accommodating the seated inversion table.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A seated inversion table comprising:
a support frame assembly comprising:
two first support rods disposed at two sides of the support frame assembly respectively; each one of the first support rods comprising:
a fixing portion; and
two second support rods, an upper end of each one of the second support rods mounted on a respective one of the first support rods;
two hand rest assemblies pivotably mounted on the two sides of the support frame assembly respectively; each one of the hand rest assemblies comprising:
a linking set, the two linking sets of the two hand rest assemblies connected to the two first support rods respectively or connected to the two second support rods respectively;
a hand rest securely mounted on the linking set; and
a controlling set securely mounted on the hand rest, the two controlling sets of the two hand rest assemblies selectively fixing the two fixing portions of the two first support rods respectively;
a seat assembly pivotably mounted on the support frame assembly and comprising:
a seat frame pivotably mounted on the support frame assembly, and between the two first support rods or between the two second support rods;
a seat cushion securely mounted on the seat frame; and
a back cushion pivotably mounted on the support frame assembly; and
a foot-clamping frame assembly mounted on the support frame assembly;
wherein when the two controlling sets respectively fix the two fixing portions, the linking set of the two hand rest assemblies, the seat cushion, and the back cushion are non-tiltable; when the two controlling sets do not fix the two fixing portions, the linking sets of the two hand rest assemblies, the seat cushion, and the back cushion are tiltable.

2. The seated inversion table as claimed in claim 1, wherein:
each one of the fixing portions forms:
a plurality of fixing cavities; and
each one of the controlling sets comprises:
an engaging component selectively engaging one of the fixing cavities of the corresponding fixing portion.

3. The seated inversion table as claimed in claim 2, wherein each one of the controlling sets further comprises:
a handle movably or rotatably mounted on the hand rest of the corresponding hand rest assembly; and
a cable, one end of the cable connected to the handle, and another end of the cable connected to the engaging component;
wherein the handle can drive the engaging component to move into or out of one of the fixing cavities via the cable.

4. The seated inversion table as claimed in claim 3, wherein:
each one of the first support rods is hollow, and the fixing cavities of each one of the first support rods communicate with an inner space of said first support rod; each two of the fixing cavities are defined as a pair and the fixing cavities in each pair face to each other;
the linking set of each one of the hand rest assemblies are mounted through the inner space of the corresponding first support rod and includes:
a pivoting shaft mounted through the corresponding first support rod; and
at least one groove selectively facing to one of the pairs of the fixing cavities and disposed around the engaging component of the corresponding controlling set; said engaging component capable of moving in a lengthwise direction of the at least one groove; and
each one of the controlling sets further comprises:
an elastic component, one end of the elastic component securely mounted on the pivoting shaft of the linking set of the corresponding hand rest assembly and another end of the elastic component securely mounted on the engaging component of the controlling set, thereby the engaging component prone to move toward the pivoting shaft and into one of the pairs of fixing cavities.

5. The seated inversion table as claimed in claim 1, wherein the foot-clamping frame assembly is capable of rotating to be parallel with the seat cushion.

6. The seated inversion table as claimed in claim 4, wherein the foot-clamping frame assembly is capable of rotating to be parallel with the seat cushion.

7. The seated inversion table as claimed in claim 5, wherein:
the support frame assembly further comprises:
a first tilting frame pivotably mounted on the seat frame and comprising:
a plurality of first through holes; and
the foot-clamping frame assembly is pivotably mounted on the first tilting frame and comprises:
at least one second through hole selectively facing to one of the first through holes; and
a pin selectively mounted through one of the first through holes and the at least one second through hole at the same time, thereby fixing an angle between the foot-clamping frame assembly and the support frame assembly.

8. The seated inversion table as claimed in claim 6, wherein:
the support frame assembly further comprises:
a first tilting frame pivotably mounted on the seat frame and comprising:
a plurality of first through holes; and
the foot-clamping frame assembly is pivotably mounted on the first tilting frame and comprises:
at least one second through hole selectively facing to one of the first through holes; and
a pin selectively mounted through one of the first through holes and the at least one second through hole at the same time, thereby fixing an angle between the foot-clamping frame assembly and the support frame assembly.

9. The seated inversion table as claimed in claim 1, wherein the support frame assembly further comprises:
a first tilting frame pivotably mounted on a front end of the seat frame;
the foot-clamping frame assembly pivotably mounted on the first tilting frame;
a second tilting frame pivotably mounted on a rear end of the seat frame; the back cushion securely mounted on an upper end of the second tilting frame; and
a driving rod parallel with the seat frame and spaced apart from the seat frame; two ends of the driving rod respectively and pivotably mounted on the first tilting frame and a lower end of the second tilting frame.

10. The seated inversion table as claimed in claim 8, wherein:
the first tilting frame of the support frame assembly is pivotably mounted on a front end of the seat frame;
the support frame assembly further comprises:
a second tilting frame pivotably mounted on a rear end of the seat frame; the back cushion securely mounted on an upper end of the second tilting frame; and
a driving rod parallel with the seat frame and spaced apart from the seat frame; two ends of the driving rod respectively and pivotably mounted on the first tilting frame and a lower end of the second tilting frame.

11. The seated inversion table as claimed in claim 9, wherein the support frame assembly further comprises:
a rear swinging rod being U-shaped; two ends of the U-shaped rear swinging rod respectively and pivotably mounted on the two first support rods, and the second tilting frame pivotably mounted on a bottom side of the U-shaped rear swinging rod.

12. The seated inversion table as claimed in claim 10, wherein the support frame assembly further comprises:
a rear swinging rod being U-shaped; two ends of the U-shaped rear swinging rod respectively and pivotably mounted on the two first support rods, and the second tilting frame pivotably mounted on a bottom side of the U-shaped rear swinging rod.

13. The seated inversion table as claimed in claim 1, wherein the support frame assembly further comprises:
a front swinging rod being U-shaped; two ends of the U-shaped front swinging rod respectively and pivotably mounted on the two first support rods, the linking set of the two hand rest assemblies respectively connected to two arms of the U-shaped front swinging rod, and the seat assembly pivotably mounted on a bottom side of the U-shaped front swinging rod.

14. The seated inversion table as claimed in claim 12, wherein the support frame assembly further comprises:
a front swinging rod being U-shaped; two ends of the U-shaped front swinging rod respectively and pivotably mounted on the two first support rods, the linking set of the two hand rest assemblies respectively connected to two arms of the U-shaped front swinging rod, and the seat assembly pivotably mounted on a bottom side of the U-shaped front swinging rod.

15. The seated inversion table as claimed in claim 1, wherein the linking set of each one of the hand rest assemblies comprises:
a connecting rod including a first end and a second end opposite to each other; the first end of the connecting rod connected to the support frame assembly; and
a driven rod including an upper end and a lower end opposite to each other and a middle portion between the upper end and the lower end of the driven rod; the middle portion pivotably mounted on the corresponding first support rod; the hand rest mounted on the upper end of the corresponding driven rod, and the lower end of the driven rod pivotably mounted on the second end of the connecting rod.

16. The seated inversion table as claimed in claim 14, wherein the linking set of each one of the hand rest assemblies comprises:
a connecting rod including a first end and a second end opposite to each other; the first end of the connecting rod connected to the support frame assembly; and
a driven rod including an upper end and a lower end opposite to each other and a middle portion between the upper end and the lower end of the driven rod; the middle portion pivotably mounted on the corresponding first support rod; the hand rest mounted on the upper end of the corresponding driven rod, and the lower end of the driven rod pivotably mounted on the second end of the connecting rod.
